(19) United States
(12) Patent Application Publication
(10) Pub. No.: US 2007/0099164 A1
(43) Pub. Date: May 3, 2007

(54) Systems and methods for versioning course content in an electronic learning system

(76) Inventors: Marcus Philipp, Dielheim (DE); Holger Bohle, Dielheim (DE); Andreas Krebs, Karlsruhe (DE); Christian Hochwarth, Wiesloch (DE); Martin Erhard, Karlsruhe (DE)

Correspondence Address: RICHARD F. JAWORSKI;Cooper & Dunham LLP, 1185 Avenue of the Americas, New York, NY, 10036, US

(21) Appl. No.: 11/262,594

(22) Filed: Oct. 31, 2005

(51) Int. Cl. G09B 3/00

(52) U.S. Cl. 434/350; 434/362

(57) ABSTRACT

A method for versioning course content in an electronic learning system includes selecting a category for changes to be made to the course content in the electronic learning system and associating system behaviors to the selected category.

### BACKGROUND OF THE DISCLOSURE

1. Field of the Disclosure

The present disclosure relates generally to versioning and in particular, to systems and methods for versioning course content in an electronic learning system.

2. Description of the Related Art

Electronic learning systems (“ELS”) provide users with the ability to access course content directly from their computers, without the need for intermediaries, such as teachers, tutors, and the like. Such computer-based systems have proven attractive for precisely this reason.

Systems exist which allow users to book ELS training electronically. These conventional systems include courses, which may only be taken as an individual course and courses which may be taken as part of a curriculum. The courses may include web-based courses allowing a learner to take courses over the web using content provided by the ELS.

However, when an author desires to make changes to content being provided by the ELS, the training administrator or system administrator has to look over the new versions of the content in the training administration system and relate the new versions to a new training. For each content version, the administrator has to determine what the changes are and has to manually enter the changes into the content. The administrator is also given the task of informing all users of that content that there has been a modification to the content,

Accordingly, there is a need for a reliable and efficient way to modify course content in an ELS so that the modifications are easily and efficiently made and learners can be automatically notified, if desired, in a timely and efficient manner.

### SUMMARY

A method for versioning course content in an electronic learning system comprises selecting a category for changes to be made to the course content in the electronic learning system and associating system behaviors to the selected category.

A user interface for use in versioning course content in an electronic learning system comprises prompting a content author to select a category for changes to be made to the course content in the electronic learning system and prompting the training administrator to associate system behaviors to the selected category.

A method for modifying course content in an electronic learning system comprises prompting a user to sign onto the electronic learning system, prompting the learner to upload updates to the course content, at this point the learner can decide in which way the system should behave.

A system for versioning course content in an electronic learning system comprises a system for allowing a learner to select a category for changes to be made to the course content in the electronic learning system and a system for allowing a training administrators to associate system behaviors to the selected category.

A system for providing a user interface for use in versioning course content in an electronic learning system comprises a system for prompting a content author to select a category for changes to be made to the course content in the electronic learning system and a system for prompting the training administrator to associate system behaviors to the selected category.

A system for modifying course content in an electronic learning system comprises a system for prompting a user to sign onto the electronic learning system, a system for prompting the user to upload updates to the course content, a system for prompting the user to select a category of changes for the updates to the course content and a system for performing one or more system behaviors based on the category of changes selected by the user.

A computer recording medium including computer executable code for versioning course content in an electronic learning system comprises code for allowing a user to select a category for changes to be made to the course content in the electronic learning system and code for allowing the user to associate system behaviors to the selected category.

A computer recording medium including computer executable code for providing a user interface for use in versioning course content in an electronic learning system comprises code for prompting a user to select a category for changes to be made to the course content in the electronic learning system and code for prompting the user to associate system behaviors to the selected category.

A computer recording medium including computer executable code for modifying course content in an electronic learning system comprises code for prompting a user to sign onto the electronic learning system, code for prompting the user to upload updates to the course content, code for prompting the user to select a category of changes for the updates to the course content and code for performing one or more system behaviors based on the category of changes selected by the user.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram of a computer system capable of implementing embodiments of the present disclosure;

FIG. 2 is a block diagram of an electronic learning system according to an embodiment of the present disclosure;

FIG. 3 is a flow chart for describing how system behaviors are associated with categories according to embodiments of the present disclosure;

FIG. 4 is a flow chart for describing steps performed by an author for modifying course content according to embodiments of the present disclosure;

FIG. 5 is a flow chart for describing the steps performed by the electronic learning system according to embodiments of the present disclosure; and

FIG. 6 shows an example of categories and associated system behaviors according to an embodiment of the present disclosure.

### DETAILED DESCRIPTION

In describing preferred embodiments of the present disclosure illustrated in the drawings, specific terminology is employed for sake of clarity. However, the present disclosure is not intended to be limited to the specific terminology so selected and it is to be understood that each specific element includes all technical equivalents which operate in a similar manner.

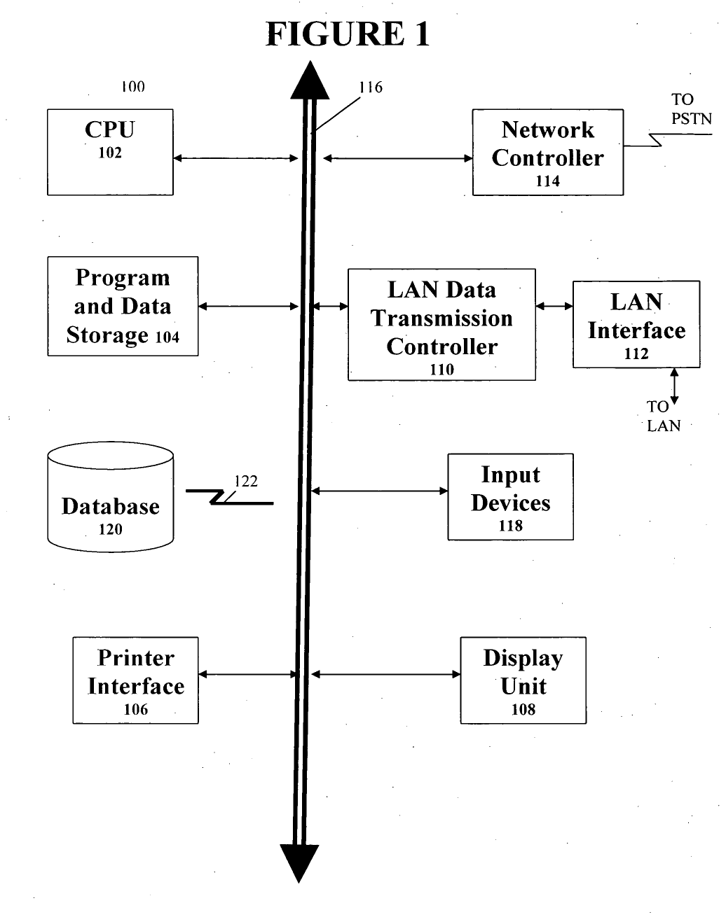

FIG. 1 shows an example of a computer system 100 which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

The computer system 100 is merely exemplary. The specific embodiments described herein are illustrative, computer system(s) as referred to herein may include(s) individual computers, servers, computing resources, networks, etc., and many variations can be introduced on these embodiments without departing from the spirit of the disclosure or from the scope of the appended claims.

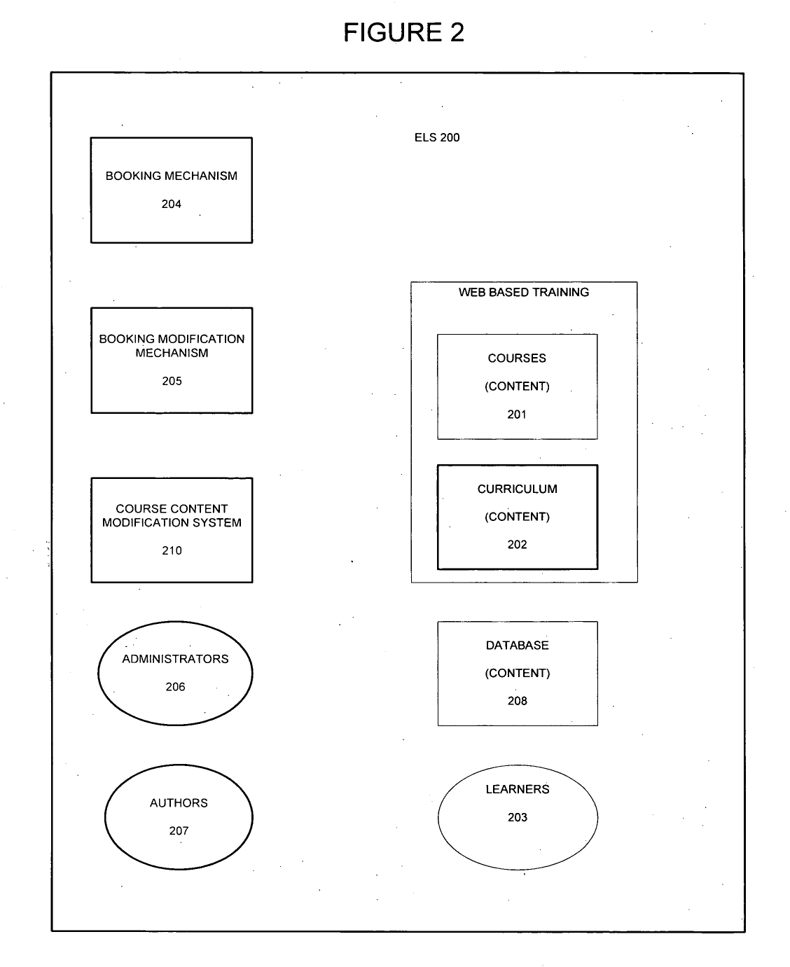

FIG. 2 shows an electronic learning system (ELS) 200. The ELS manages a set of courses 201, a set of curriculums 202, and a set of learners 203 in the ELS. A course constitutes a training that provides instruction about a particular topic. Associated with each course is information specifying course constraints, such as course start and end dates, course prerequisites, and qualifications imparted by the course.

The set of courses 201 can include different types of courses including web-based courses, classroom courses, and on-the-job courses. An on-the-job course is a course that includes one or more work assignments and a required time interval for completing the work assignments. A classroom course is a live course that is given by an instructor in a fixed location at a fixed time. A web-based course is a course that is delivered over the Internet. With web-based courses, there is generally not a fixed location and there often is not a fixed time either. Examples of web-based courses include on-line tutorial programs and presentations. Content database 208 includes content used by web-based courses 201.

A curriculum is a group of two or more courses selected from a set of courses managed by the system. Within the group, the courses are arranged in a sequence that determines the order in which the courses must be taken. Associated with each curriculum is information specifying the curriculum constraints, such as curriculum start and end dates, curriculum prerequisites, and qualifications imparted by the curriculum.

A learner is a user of the ELS that is authorized to book courses or curriculum managed by the curriculum management system. For each learner, the ELS maintains a learner profile that keeps track of the learner's learning progress in a particular course and/or curriculum, the learner's bookings and the qualifications earned by the learner, etc.

ELS 200 also includes a booking mechanism 204 for booking courses and curriculum, a booking modification mechanism 205 for making modifications to bookings.

ELS 200 also includes one or more administrators 206 and one or more authors 207. Administrators 206 are responsible for maintaining the electronic learning system 200, including setting up courses and curriculum and otherwise overseeing operation of the system.

Authors 207 design and write the content of courses 201. The content is uploaded by the author to database 208. The content may include on-line text books and/or any other type of learning materials including on-line testing materials, etc. An author is said to publish content to system 200 when it is uploaded to content database 208 and otherwise made available to the system 200. Authors 207 may periodically make changes to their content via course content modification system 210. Administrators 206 may also be given the option to modify content using course content modification system 210. For example, authors (and/or administrators) may correct grammar in the content, add, remove and/or modify chapters, etc.

According to an embodiment of the present disclosure, when an author makes changes to his content, he is prompted to select a category for the changes from a predetermined set of categories. For example, the author may be given the choice of selecting whether the changes are minor, major, etc. Course content modification system 210 will then perform predefined system behaviors based on the category selected.

Examples of categories of content changes that can be selected from include “minor changes”, “major changes”, change “X's” to “Y's”, “added material”, “grammatical changes”, etc. For example, if only a minor title correction is being made, the author might select “minor change” for the category of the change. In contrast, “major changes” might be selected when correcting incorrect/outdated material in the content. “Change “X's” to “Y's” might be selected when changing all instances of the word “internet” to “Internet”, for example. “Added material” might be selected when new chapters are being added to the content. “Grammatical changes” can be selected when, for example, corrections to formal matters such as grammar, syntax and idiom are being made.

Examples of system behaviour that can be associated with a category of change include automatic update, manual update, delete learning progress, preserve learning progress, newer version free, charge for newer version, etc. The administrator of the ELS 200 associates the system behaviors that are to be performed for each category of change. If automatic update is associated with the category, the system will automatically give the new version of the content to the learner. The learner may be prompted that he has a new version of the content when he goes to the web-based training. If manual update is associated with the category, the learner will be prompted that a newer version of the content exists and given the option of using and/or downloading the newer version for use with the web-based training. If delete learning progress is associated with a category of change, the system will prompt the learner that a new version of the content exists and that any learning progress he previously obtained using the old version of the content is obsolete and thus his learning progress on that content has been deleted from his profile. The learning progress may be preserved if the system behaviour preserve learning progress is associated with the category of change. Preserve learning progress may be set as a default setting for all categories, unless it is otherwise changed by selecting delete learning progress as a system behaviour. Free of charge for new content is used to determine whether the system should charge the learner for the newer content. For example, if major changes are made to the content, the administrator might want to charge the learner for that new content. Of course, other categories and/or system behaviours may be used as desired.

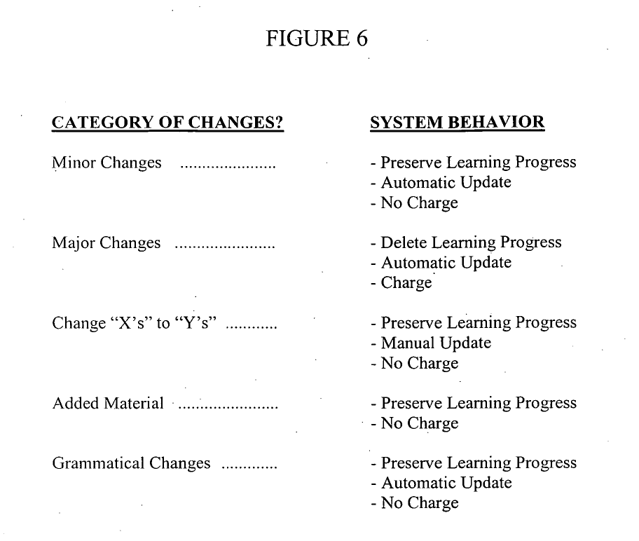

FIG. 6 is an example of category of changes and associated behaviors. If the author selects “minor change” for the changes made to the content, the system 210 will preserve learning progress, perform automatic update of the content and will not charge the learner for the updated content. If the author selects “major change” for the changes made to the content, the system 210 will delete the learner's learning progress from his profile, will automatically update the content and will charge the learner for the updated content. If the category of change is “change X's to Y's”, the learner's learning progress is preserved, the user is prompted whether he wants to make the update to his content and the learner is not charge, etc.

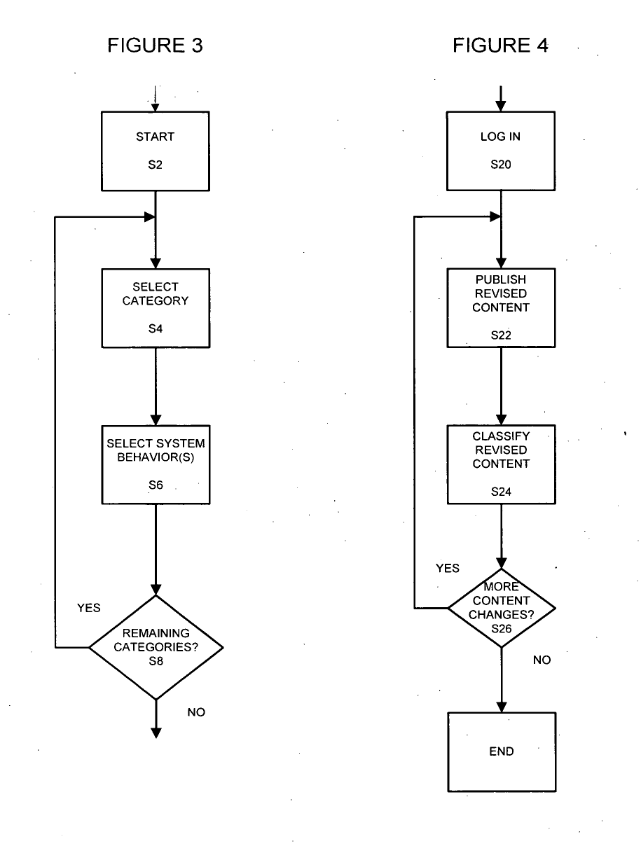

FIG. 3 is a flow chart for describing steps for setting up categories and behaviours according to an embodiment of the present disclosure. An administrator of a company's electronic learning system can be guided through the process of setting up categories and behaviours by use of one or more graphical user interfaces (GUIs). According to an embodiment of the present disclosure, after the administrator logs onto the system (Step S2) or is otherwise granted access to the system, the administrator is given a predefined set of categories from which to choose (Step S4). According to other embodiments, the administrator is given prompts as to whether he wants to modify the predefined set of categories or to define the set of categories himself. After selecting a category, the administrator is prompted to choose system behaviours to be associated with that category (Step S6). According to an embodiment of the present disclosure, the administrator is given a predefined set of behaviours from which to choose. According to other embodiments, the administrator is given prompts as to whether he wants to modify the predefined set of categories or to define the set of categories himself. After behaviours for that category are selected, the administrator is prompted whether he has any other categories to set up (Step S8). If there are other categories to set up (Yes, Step S8), the process returns to Step S4 and the administrator is again prompted to select a category and the process repeats until there are no more categories that the administrator wants to set up (No, Step S8).

FIG. 4 is a flow chart for describing steps performed by an author for modifying his content on the system. Authors may be given temporary or permanent passwords for gaining access to the system for uploading new and/or modified content. After an author logs onto the system (Step S20) or is otherwise given access to the system, the author is prompted to specify what content he desires to modify (Step S22). For example, the author may be prompted to input a course number and/or specify the content he wishes to modify in some other way. The author may be given a unique password associated with that content so that only he (or an administrator with modification rights) can modify his content. The author is prompted to upload the new content or to otherwise specify the changes to be made to the content. For example, the author may choose to modify his content by changing all instances of the word “internet” to “Internet”. The author is then prompted to classify the changes to the content by selecting from one of the predefined categories (Step S24). In this instance, the author would choose the category “Change all “X's” to “Y's”.” The author is then prompted whether there is additional content to modify (Step S26). If there is additional content (Yes, Step S26), the process returns to Step S22 and the process repeats until there are no additional content changes to be made (Step S26) and the process ends (Step S28).

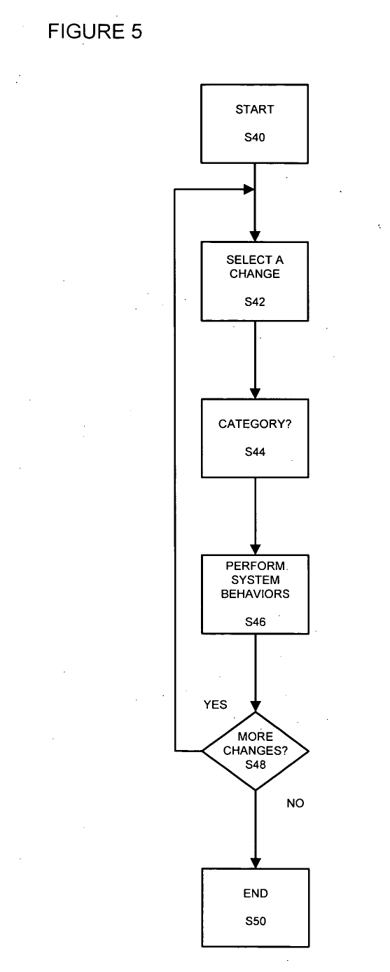

FIG. 5 is a flow chart for describing steps performed by the system after the author or authors have modified content. The administrator can start the process or the process can start automatically some time after the author has modified and classified the content (Step S40). The system will then select a change of content that has been made (Step S42) and determine the category the author assigned to the change of content (Step S44). The system will then automatically perform the system behaviours associated with that category (Step S46). For example, if the author selected category “Minor Changes” (see FIG. 6), the system would automatically preserve each learners learning progress in his profile. That is, each learner using the modified content would have their learning progress preserved. The system would also automatically update each learner's version of the course content and would not charge the learners for the change. The system then determines if there are additional changes (Step S48). If there are additional changes (Yes, Step S48), the process returns to Step S42 and the procedure repeats. If there are currently no additional changes (No, Step S48), the process ends (Step S50).

Although the above embodiments describe changes made by the author, parties other than the author may make changes to the content. For example, administrators or training managers may also desire to make changes to the content. In these cases, the party making the change to the content can select the category of change being made.

The systems and methods of the present disclosure can be implemented in digital electronic circuitry, or in computer hardware, firmware, software, or in combinations of them. The systems and methods can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with the systems and methods of the present disclosure can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

To provide for interaction with a user, the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual-feedback, auditory feedback, or tactile feedback; and input from the user can be received in any form, including acoustic, speech, or tactile input.

The systems and methods of the present disclosure can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the invention, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on respective computers and having a client-server relationship to each other.

The systems and methods of the present disclosure have been described in terms of particular embodiments. Other embodiments are within the scope of the following claims. For example, although the course content modification system has been described as a component in a larger ELS, it can also be implemented in other systems or as a stand-alone system.

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments may be combined with each other and/or substituted for each other within the scope of this disclosure and appended claims.

Numerous additional modifications and variations of the present disclosure are possible in view of the above-teachings. It is therefore to be understood that within the scope of the appended claims, the present disclosure may be practiced other than as specifically described herein.

What is claimed is:

1. A method for versioning course content in an electronic learning system, comprising:
selecting a category for changes to be made to the course content in the electronic learning system; and
associating system behaviors to the selected category.

2. The method for versioning course content in an electronic learning system, as recited in claim 1, wherein the category is selected from at least one of major change, minor change, grammatical change and added material change.

3. The method for versioning course content in an electronic learning system, as recited in claim 1, wherein the system behaviors are selected from at least one of automatic update, manual update, delete learning progress, preserve learning progress, new version for free and charge for new version.

4. A user interface for use in versioning course content in an electronic learning system, comprising:
prompting a user to select a category for changes to be made to the course content in the electronic learning system; and
prompting the user to associate system behaviors to the selected category.

5. The user interface for versioning course content in an electronic learning system, as recited in claim 4, wherein the category is selected from at least one of major change, minor change, grammatical change and added material change.

6. The user interface for versioning course content in an electronic learning system, as recited in claim 4, wherein the system behaviors are selected from at least one of automatic update, manual update, delete learning progress, preserve learning progress, new version for free and charge for new version.

7. A method for modifying course content in an electronic learning system, comprising:
prompting a user to sign onto the electronic learning system;
prompting the user to upload updates to the course content;
prompting the user to select a category of changes for the updates to the course content; and
performing one or more system behaviors based on the category of changes selected by the user.

8. The method for modifying course content in an electronic learning system as recited in claim 7, wherein the user comprises one of an author of the course content being modified and an administrator of the electronic learning system.

9. The method for modifying course content in an electronic learning system, as recited in claim 7, wherein the category is selected from at least one of major change, minor change, grammatical change and added material change.

10. The method for modifying course content in an electronic learning system, as recited in claim 7, wherein the system behaviors are selected from at least one of automatic update, manual update, delete learning progress, preserve learning progress, new version for free and charge for new version.

11. A system for versioning course content in an electronic learning system, comprising:
a system for allowing a user to select a category for changes to be made to the course content in the electronic learning system; and
a system for allowing a user to associate system behaviors to the selected category.

12. The system for versioning course content in an electronic learning system, as recited in claim 11, wherein the category is selected from at least one of major change, minor change, grammatical change and added material change.

13. The system for versioning course content in an electronic learning system, as recited in claim 11, wherein the system behaviors are selected from at least one of automatic update, manual update, delete learning progress, preserve learning progress, new version for free and charge for new version.

14. A system for providing a user interface for use in versioning course content in an electronic learning system, comprising:
a system for prompting a user to select a category for changes to be made to the course content in the electronic learning system; and
a system for prompting the user to associate system behaviors to the selected category.

15. The system for providing the user interface for versioning course content in an electronic learning system, as recited in claim 14, wherein the category is selected from at least one of major change, minor change, grammatical change and added material change.

16. The system for providing the user interface for versioning course content in an electronic learning system, as recited in claim 14, wherein the system behaviors are selected from at least one of automatic update, manual update, delete learning progress, preserve learning progress, new version for free and charge for new version.

17. A system for modifying course content in an electronic learning system, comprising:
a system for prompting a user to sign onto the electronic learning system;
a system for prompting the user to upload updates to the course content;
a system for prompting the user to select a category of changes for the updates to the course content; and
a system for performing one or more system behaviors based on the category of changes selected by the user.

18. The system for modifying course content in an electronic learning system as recited in claim 17, wherein the user comprises one of an author of the course content being modified and an administrator of the electronic learning system.

19. The system for modifying course content in an electronic learning system, as recited in claim 17, wherein the category is selected from at least one of major change, minor change, grammatical change and added material change.

20. The system for modifying course content in an electronic learning system, as recited in claim 17, wherein the system behaviors are selected from at least one of automatic update, manual update, delete learning progress, preserve learning progress, new version for free and charge for new version.

21. A computer recording medium including computer executable code for versioning course content in an electronic learning system, comprising:
code for allowing a user to select a category for changes to be made to the course content in the electronic learning system; and
code for allowing the user to associate system behaviors to the selected category.

22. The computer recording medium as recited in claim 21, wherein the category is selected from at least one of major change, minor change, grammatical change and added material change.

23. The computer recording medium as recited in claim 21, wherein the system behaviors are selected from at least one of automatic update, manual update, delete learning progress, preserve learning progress, new version for free and charge for new version.

24. A computer recording medium including computer executable code for providing a user interface for use in versioning course content in an electronic learning system, comprising:
code for prompting a user to select a category for changes to be made to the course content in the electronic learning system; and
code for prompting the user to associate system behaviors to the selected category.

25. The computer recording medium as recited in claim 24, wherein the category is selected from at least one of major change, minor change, grammatical change and added material change.

26. The computer recording medium as recited in claim 24, wherein the system behaviors are selected from at least one of automatic update, manual update, delete learning progress, preserve learning progress, new version for free and charge for new version.

27. A computer recording medium including computer executable code for modifying course content in an electronic learning system, comprising:
code for prompting a user to sign onto the electronic learning system;
code for prompting the user to upload updates to the course content;
code for prompting the user to select a category of changes for the updates to the course content; and
code for performing one or more system behaviors based on the category of changes selected by the user.

28. The computer recording medium as recited in claim 27, wherein the user comprises one of an author of the course content being modified and an administrator of the electronic learning system.

29. The computer recording medium as recited in claim 27, wherein the category is selected from at least one of major change, minor change, grammatical change and added material change.

30. The computer recording medium as recited in claim 27, wherein the system behaviors are selected from at least one of automatic update, manual update, delete learning progress, preserve learning progress, new version for free and charge for new version.
